(19) United States
(12) Patent Application Publication
(10) Pub. No.: US 2023/0087663 A1
(43) Pub. Date: Mar. 23, 2023

(54) IMAGE PROCESSING APPARATUS, IMAGE PROCESSING METHOD, AND 3D MODEL DATA GENERATION METHOD

(71) Applicant: SONY GROUP CORPORATION, Tokyo (JP)

(72) Inventor: Yuichi ARAKI, Tokyo (JP)

(73) Assignee: SONY GROUP CORPORATION, Tokyo (JP)

(21) Appl. No.: 17/802,809

(22) PCT Filed: Mar. 17, 2021
(86) PCT No.: PCT/JP2021/010754

§ 371 Date: Aug. 26, 2022

(30) Foreign Application Priority Data
Mar. 30, 2020 (JP) 2020-060384

(51) Int. Cl. G06T 7/80; G06T 17/00; G06T 15/20; H04N 23/60

(52) U.S. Cl. CPC G06T 7/80; G06T 17/00; G06T 15/20; H04N 23/64; H04N 23/74

(57) ABSTRACT

There is provided an image processing apparatus, an image processing method, and a 3D model data generation method capable of easily adjusting an image capturing environment. The image processing apparatus includes an adjustment unit that adjusts camera parameters on the basis of a comparison result between a reference image based on images obtained by capturing images of a predetermined subject at different timings, and a captured image obtained by capturing an image of the same subject in a current environment. The present disclosure is applicable to, for example, an image processing system that performs image capturing for generating a 3D model.

### TECHNICAL FIELD

The present disclosure relates to an image processing apparatus, an image processing method, and a 3D model data generation method, and more particularly, to an image processing apparatus, an image processing method, and a 3D model data generation method capable of easily adjusting an image capturing environment.

### BACKGROUND ART

There is a technique of generating a 3D model of a subject from a moving image captured from multiple viewpoints, generating a virtual viewpoint image of the 3D model matching an arbitrary viewing position, and thereby providing an image of a free viewpoint. This technique is also referred to as volumetric capture or the like.

According to the volumetric capture, it is possible to generate, for example, 3D models in units of objects such as persons, and generate virtual viewpoint images generated at different timings and including a plurality of objects. In such a case, there is a request for matching respective image capturing environments in which a plurality of objects is generated.

For example, there has been proposed a system that performs control such that an illumination situation at a time when a background image is previously captured outdoor can be played back when a foreground image is captured (see, for example, Patent Document 1.).

### CITATION LIST

### Patent Document

Patent Document 1: Japanese Patent Application Laid-Open No. 2012-175128

### SUMMARY OF THE INVENTION

### Problems to be Solved by the Invention

During image capturing at a time of generation of a 3D model, images of a subject are captured from different viewpoints by using multiple image capturing apparatuses, and therefore an operation. for matching image capturing environments is difficult.

The present disclosure has been made in view of such a situation, and makes it possible to easily adjust an image capturing environment.

### Solutions to Problems

An image processing apparatus according to one aspect of the present disclosure includes an adjustment unit that adjusts camera parameters on a basis of a comparison result between reference image based on

images obtained by capturing images of a predetermined subject at different timings, and a captured image obtained by capturing an image of the same subject in a current environment.

An image processing method according to one aspect of the present disclosure includes adjusting camera parameters on a basis of a comparison result between a reference image based on images obtained by capturing images of a predetermined subject at different timings, and a captured image obtained by capturing an image of the same subject in a current environment.

A 3D model data generation method according to one aspect of the present disclosure includes generating a 3D model of a second subject from a plurality of second captured images, and generating a virtual viewpoint image that views the generated 3D model of the second subject from a predetermined viewpoint, the plurality of second captured images being obtained by capturing images of the second subject by a plurality of image capturing apparatuses that use camera parameters adjusted on a basis of a comparison result between a reference image based on images obtained by capturing images of a first subject at different timings, and a first captured image obtained by capturing an image of the first subject in a current environment.

According to one aspect of the present disclosure, the camera parameters are adjusted on the basis of the comparison result between the reference image based on the images obtained by capturing the images of the predetermined subject at the different timings, and the captured image obtained by capturing the image of the same subject in the current environment.

Note that the image processing apparatus according to one aspect of the present disclosure can be realized by causing a computer to execute a program. In order to realize the image processing apparatus, the program executed by the computer can be provided by being transmitted via a transmission medium or by being recorded on a recording medium.

The image processing apparatus may be an independent apparatus or an internal block that makes up one apparatus.

### BRIEF DESCRIPTION OF DRAWINGS

FIG. 1 is a view for describing generation of a 3D model of a subject and display of a free viewpoint image.

FIG. 2 is a view illustrating an example of a data format of 3D model data.

FIG. 3 is a view for explaining adjustment of an image capturing environment.

FIG. 4 is a block diagram illustrating a first embodiment of an image processing system to which the present disclosure is applied.

FIG. 5 is a view illustrating an example of image capturing environment data stored in a reference camera image DB.

FIG. 6 is a view for explaining a flow of adjustment processing executed by an image processing apparatus.

FIG. 7 is a flowchart illustrating processing of the entire image processing system according to the first embodiment.

FIG. 8 is a detailed flowchart of reference image capturing environment selection processing in step S1 in FIG. 7.

FIG. 9 is a detailed flowchart of initial image capturing environment setting processing in step S2 in FIG. 7.

FIG. 10 is a detailed flowchart of image capturing environment adjustment processing in step S3 in FIG. 7.

FIG. 11 is a detailed flowchart of camera parameter adjustment processing in step S63 in FIG. 10.

FIG. 12 is a detailed flowchart of image capturing environment registration processing in step S4 in FIG. 7.

FIG. 13 is a block diagram illustrating a second embodiment of an image processing system to which the present disclosure is applied.

FIG. 14 is a view for explaining image capturing environment adjustment processing executed by as image capturing environment adjustment unit according to the second embodiment.

FIG. 15 is a flowchart illustrating processing of the entire image processing system according to the second embodiment.

FIG. 16 is a detailed flowchart of reference virtual viewpoint image generation processing in step S153 in FIG. 15.

FIG. 17 is a detailed flowchart of image capturing environment adjustment processing in step S154 in FIG. 15.

FIG. 18 is a detailed flowchart of camera parameter adjustment processing in step S193 in FIG. 17.

FIG. 19 is a block diagram illustrating a configuration example in a case where the image processing apparatus executes a function as a 3D model playback display apparatus.

FIG. 20 is a block diagram illustrating a configuration example of an embodiment of a computer to which the present disclosure is applied.

### MODE FOR CARRYING OUT THE INVENTION

Hereinafter, modes for carrying out the present disclosure (referred to as embodiments below) will be described with reference to the accompanying drawings. Note that components having substantially the same functional configuration in this description and the drawings will be assigned the same reference numerals, and redundant description will be omitted. The description will be given in the following order.

1. Outline of Volumetric Capture

2. Adjustment of Image Capturing Environment

3. First Embodiment of Image Processing System

4. Processing of Image Processing System According to First Embodiment

5. Second Embodiment of Image Processing System

6. Processing of Image Processing System According to Second Embodiment

7. Configuration of 3D Model Playback Display apparatus

8. Computer Configuration Example

### 1. Outline of Volumetric Capture

The image processing system according to the present disclosure relates to volumetric capture that generates a 3D model of a subject from moving images captured from multiple viewpoints, generating a virtual viewpoint image of the 3D model matching an arbitrary viewing position, and thereby provides an image of a free viewpoint (free viewpoint image).

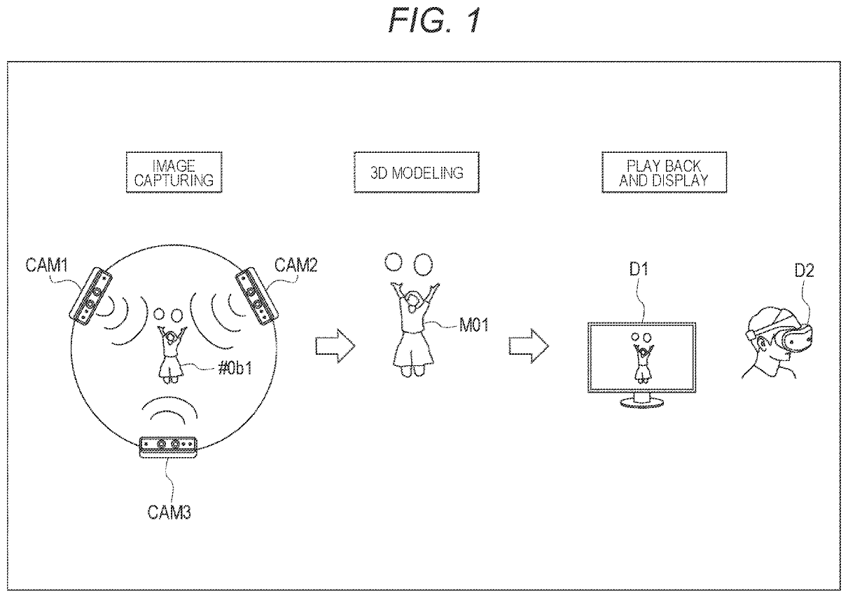

Therefore, generation of a 3D model of a subject and display of a free viewpoint image that uses the 3D model will be briefly described first with reference to FIG. 1.

For example, a plurality of captured images can. be obtained by making a plurality of image capturing apparatuses image a predetermined image capturing space in which a subject such as a person is arranged from the outer periphery of the predetermined capturing space. The captured images include, for example, moving images. Although three image capturing apparatuses CAM1 to CAM3 are arranged so as to surround a subject #Ob1 in the example in FIG. 1, the number of image capturing apparatuses CAMs is not limited to three and is arbitrary. The number of the image capturing apparatuses CAM at a time of image capturing is a known number of viewpoints at a time when a free viewpoint image is generated, and therefore as the number is larger, the free viewpoint image can be expressed with higher accuracy. The subject #Ob1 is a person who is making a predetermined motion.

Captured images obtained from a plurality of image capturing apparatuses CAM in different directions are used to generate a 3D object MO1 that is a 3D model of the subject #Ob1 that is a display target in the image capturing space (3D modeling). For example, a method such as Visual Hull that cuts out a three-dimensional shape of a subject by using captured images in different directions is used to generate the 3D object MO1.

Then, data (also referred to as 3D model data) of one or more 3D objects among one or more 3D objects existing in the image capturing space is transmitted to a playback side apparatus and played back. That is, the playback side apparatus renders the 3D objects on the basis of the obtained data of the 3D objects, and then a viewing device of a viewer displays a 3D shape video image. FIG. 1 illustrates an example where the viewing device is a display D1 or a head mounted display (HMD) D2.

The playback side can request only a viewing target 3D object of the one or more 3D objects existing in the image capturing space, and cause the viewing device to display viewing target 3D object. For example, the playback side assumes a virtual camera whose image capturing range is a viewing range of the viewer, requests only a 3D object captured by the virtual camera among the multiple 3D objects existing in the image capturing space, and causes the viewing device to display the 3D object. The viewpoint (virtual viewpoint) of the virtual camera can be set at an are position such that the viewer can see the subject from an arbitrary viewpoint in the real world. The 3D object can be appropriately synthesized with a video image of a background that represents a predetermined space.

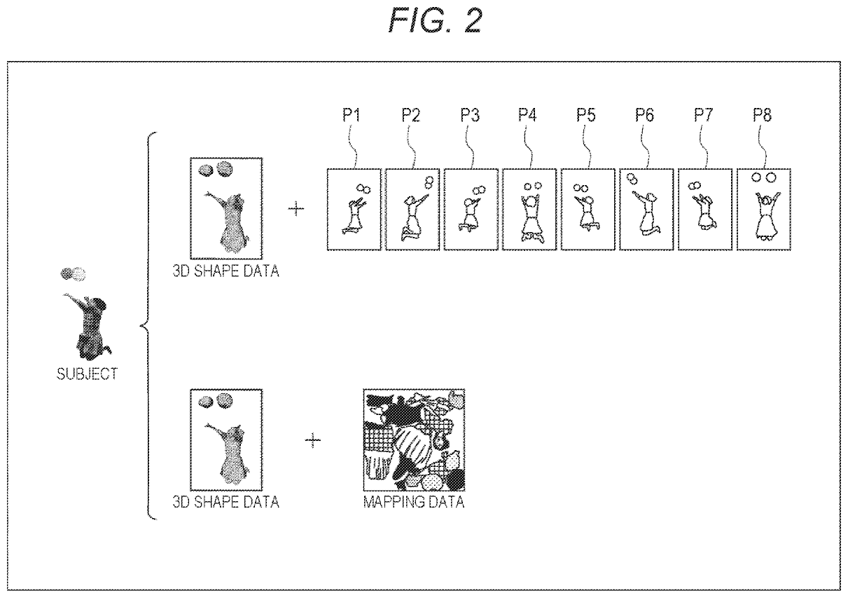

FIG. 2 illustrates an example of a data format of general 3D model data.

The 3D model data is generally expressed by 3D shape data that represents a 3D shape (geometry information) of a subject, and texture data that represents color information of the subject.

The 3D shape data is expressed in, for example, a point cloud format that expresses a three-dimensional position of a subject by a set of points, a 3D mesh format that expresses the three-dimensional position as connection between a vertex and a vertex called a polygon mesh, and a voxel format that expresses the three-dimensional positon as a set of cubes called voxels.

Texture data has, for example, a multi-texture format that stores a captured image (two-dimensional texture image) captured by each image capturing apparatus CAM, and a UV mapping format that stores and expresses as a UV coordinate system a two-dimensional texture image attached to each point or each polygon mesh that is 3D shape data.

As illustrated in an upper part in FIG. 2, a format that describes 3D model data as 3D shape data and a multi-texture format that stores a plurality of captured images P1 to P8 captured by the respective image capturing apparatuses CAM is a view dependent format in which color information may change depending on a virtual viewpoint (virtual camera position).

By contrast with. this, as illustrated in a lower part in FIG. 2, a format that describes 3D model data as 3D shape data and a DV mapping format that maps texture information of a subject on a UV coordinate system is a view independent format in which the color information is the same depending on the virtual viewpoint (virtual camera position).

### 2. Adjustment of Image Capturing Environment

The 3D model (3D object) of the subject generated by the procedure as described with reference to FIG. 1 can also arrange a plurality of 3D models generated at different timings in the same space, and display (play back) a plurality of 3D models, or display (play back) only one 3D model among a plurality of 3D models simultaneously captured and generated in the same image capturing space.

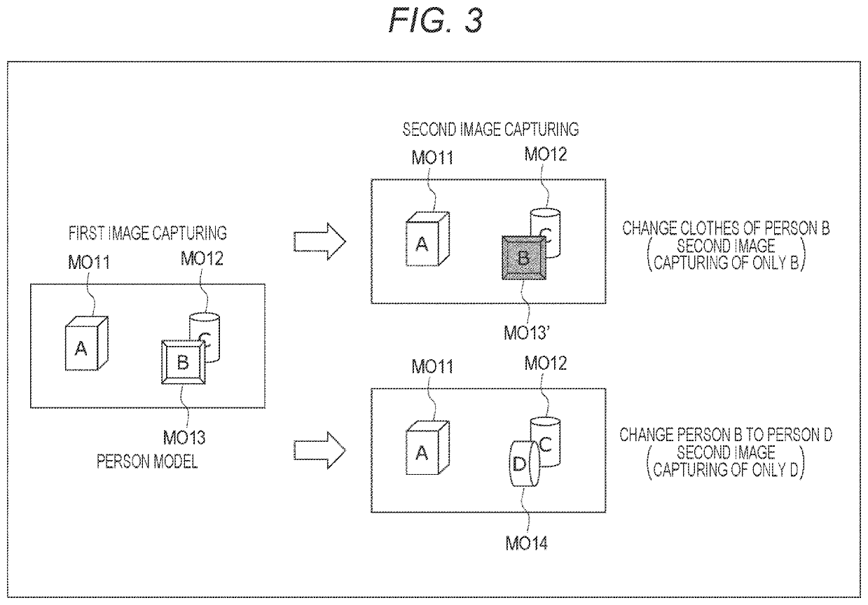

For example, as illustrated in FIG. 3, it is assumed that, during first image capturing, images of three persons A, B, and C are captured, and respective 3D objects MO11 to MO13 are generated. Then, in a case where clothes of the person B need to be changed or in a case where the person B needs to be changed to a person D, it is not necessary to gather and capture images of the three persons A, B, and C again, and an image of only the person B whose clothes have been changed is only required to be captured again or an image of only the person D is only required to be captured again.

However, in a case where brightness does not match or a setting of a focus is different between a time of the first image capturing and a time of second image capturing of the person B whose clothes have been changed or a time of the second image capturing of only the person D, quality of content is changed before and after replacement of the 3D object.

Therefore, although it is necessary to match an image capturing environment at a time of the first image capturing and an image capturing environment at a time of the second image capturing as much as possible, images of a subject are captured from different viewpoints by using multiple image capturing apparatuses during image capturing at a time of generation of a 3D model, and therefore an operation for matching the image capturing environments is difficult.

Therefore, the image processing system according to the present disclosure is a system that can easily adjust an image capturing environment such that a plurality of image capturing environments captured at different timings can be matched during image capturing at a time of generation of a 3D model.

Hereinafter, a detailed configuration of the image processing system according to the present disclosure will be described.

### 3. First Embodiment of Image Processing System

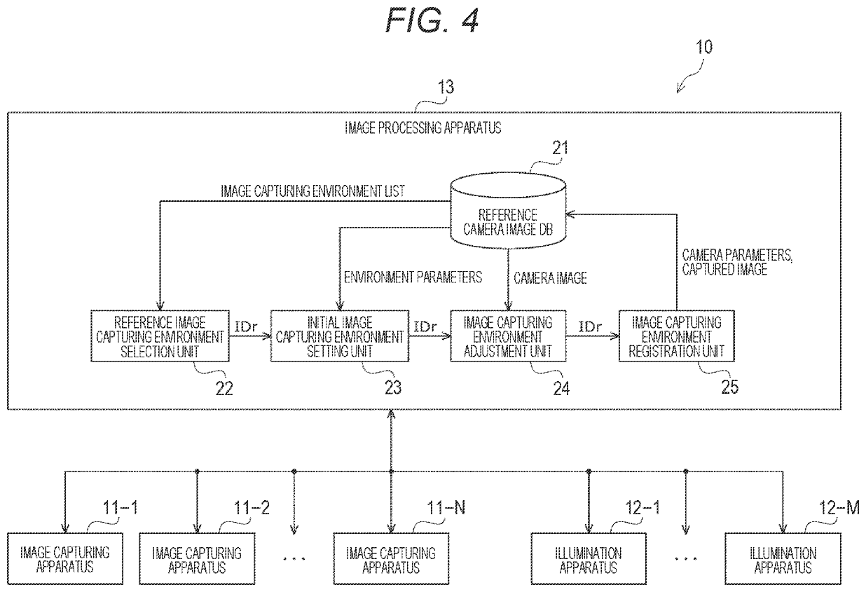

FIG. 4 is a block diagram illustrating a first embodiment of the image processing system to which the present disclosure is applied.

An image processing system 10 in FIG. 4 includes N (N>2) image capturing apparatuses 11-1 to 11-N, N (M>0) illumination apparatuses 12-1 to 12-M, and an image processing apparatus 13. The image processing apparatus 13, and the image capturing apparatuses 11-1 to 11-N and the illumination apparatuses 12-1 to 12-M are connected by, for example, a predetermined communication cable or a network such as a local area network (LAN). Furthermore, each apparatus may be connected not only by wired communication but also by wireless communication.

Note that, in the following description, the N image capturing apparatuses 11-1 to 11-N will be referred to simply as the image capturing apparatus 11 unless otherwise distinguished in particular, and the N illumination apparatuses 12-1 to 12-M will be referred to simply as the illumination apparatus 12 unless otherwise distinguished in particular. The N image capturing apparatuses 11 are assigned numbers in a predetermined order.

The N image capturing apparatuses 11-1 to 11-N are arranged in a predetermined image capturing space so as to surround the subject such that images of the subject are captured from different directions. The image capturing apparatus 11 performs image capturing for generating a 3D model (3D object) of a subject. Start and end timings of image capturing are controlled by the image processing apparatus 13, and image data of a still image or a moving image obtained by image capturing is also supplied to the image processing apparatus 13.

The M illumination apparatuses 12-1 to 12-M are arranged in a predetermined. image capturing space so as to surround the subject such that the subject is irradiated with light from different directions. The illumination apparatus 12 irradiates the subject with light when an image of the subject is captured. An illumination timing and illumination conditions of the illumination apparatus 12 are controlled by the image processing apparatus 13.

A subject is arranged at the center of the image capturing space surrounded by the N image capturing apparatuses 11 and the M illumination apparatuses 12. As a subject for matching a current image capturing environment and a past image capturing environment, for example, an object such as a mannequin. whose conditions do not change is used.

The image processing apparatus 13 includes a reference camera image DB 21, a reference image capturing environment selection unit 22, an initial image capturing environment setting unit 23, an image capturing environment adjustment unit 24, and an image capturing environment registration unit 25.

Note that the image processing apparatus 13 according to the first embodiment employs a configuration that supports a case where the image capturing space in which image capturing is performed this time and a past image capturing space for which an image capturing environment needs to be matched are the same, and the number of the image capturing apparatuses 11, a three-dimensional position of the image capturing apparatus 11 specified by (x, y, z), and roll of the posture of the image capturing apparatus 11 specified by (yaw, pitch, roll) have not changed.

The image processing apparatus 13 executes processing of adjusting an image capturing environment at a time of image capturing for generating a 3D model (3D object) of a subject. Specifically, the image processing apparatus 13 adjusts a three-dimensional position (x, y, z) and posture (yaw, pitch, roll) of the image capturing apparatus 11, and a focus (focus position), a shutter speed, and a gain at a time of image capturing for each image capturing apparatus 11, and adjusts an illuminance and a color temperature at a time of illumination for each illumination apparatus 12. Here, numerically settable parameters are the shutter speed and the gain of the image capturing apparatus 11 and the illuminance and the color temperature of the illumination apparatus 12. However, due to the premise, the three-dimensional position (x, y, z) and roll of the image capturing apparatus 11 have not been changed from those at a time of past image capturing to be matched.

The reference camera image DB 21 stores data (also referred to as image capturing environment data) for specifying an image capturing environment at a time when image capturing for generation of a 3D model is previously performed, such as each parameter of the above image capturing apparatus 11 and illumination apparatus 12 controlled by the image processing apparatus 13, and supplies the data to each unit in the apparatus as necessary.

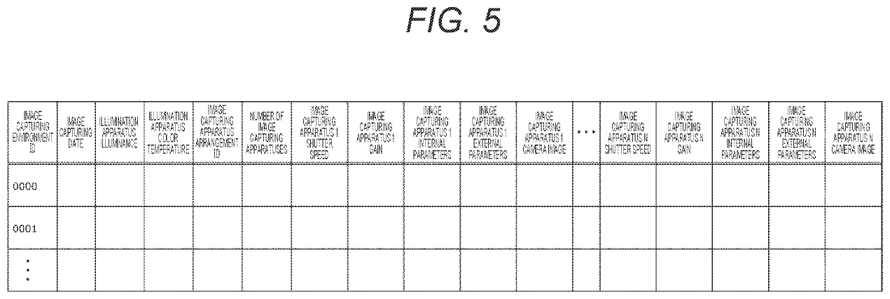

FIG. 5 is a view illustrating an example of image capturing environment data stored in the reference camera image DB 21.

The reference camera image DB 21 stores image capturing environment IDs, image capturing dates, illuminances of the illumination apparatuses 12, color temperatures of the illumination apparatuses 12, image capturing apparatus arrangement IDs, the number of the image capturing apparatuses 11, and parameters and camera images of a number of image capturing apparatuses 11 per image capturing apparatus 11.

The image capturing ID is identification information for identifying each image capturing environment data stored in the reference camera image DB 21. The image capturing date is information indicating a date and a time of image capturing.

An illumination apparatus illuminance and an illumination apparatus color temperature represent setting values of the illuminance and the color temperature of the illumination apparatus 12 at a time when image capturing is performed. The illuminance and the color temperature configure illumination parameters of the illumination apparatus 12.

The image capturing apparatus arrangement ID is information for identifying an arrangement method of the image capturing apparatus 11. For example, ID=1 indicates an arrangement method where the four image capturing apparatuses 11 are arranged at four corners, and ID=2 indicates an arrangement method where the 16 image capturing apparatuses 11 including the eight image capturing apparatuses 11 arranged around a horizontal direction, the four image capturing apparatuses 11 arranged around an obliquely upper side, and the four image capturing apparatuses 11 arranged around an obliquely lower side, that is, the arrangement method is determined on the basis of the value of the ID.

The number of image capturing apparatuses represents the number of the image capturing apparatuses 11 used for image capturing.

As parameters (camera parameters) of the image capturing apparatus 11, a shutter speed, a gain, internal parameters, and external parameters are stored. The internal parameters are optical center coordinates (cx, cy) and a focal length (fx, fy) of the image capturing apparatus 11, and the external parameters are a three-dimensional position (x, y, z) and posture (yaw, pitch, and roll).

The camera image is an image that is obtained by capturing an image of the subject by the image capturing apparatus 11 when this image capturing apparatus 11 previously performs image capturing, and is an image that may be compared as a reference image during subsequent image capturing. The camera image is a still image, yet may be a moving image.

As described above, the reference camera image DB 21 stores camera parameters and illumination parameters for capturing images of a predetermined subject previously (at different timings), and camera images. The description returns to FIG. 4.

The reference image capturing environment selection unit 22 obtains an image capturing environment list that is a list of items of image capturing environment data stored in the reference camera image DB 21, and presents the image capturing environment list to the user by, for example, displaying the image capturing environment list on a display. Then, the reference image capturing environment selection unit 22 causes the user to select a desired image capturing environment ID, and thereby causes the user to select one predetermined image capturing environment in the image capturing environment list. The image capturing environment ID selected by the user is supplied as an image capturing environment IDr to be referred to for current image capturing to the initial image capturing environment setting unit 23.

The initial image capturing environment setting unit 23 obtains environmental parameters of the image capturing environment IDr from the reference camera image DB 21 on the basis of the image capturing environment IDr supplied from the reference image capturing environment selection unit 22. The environmental parameters correspond to the camera parameters of the image capturing apparatus 11 and the illuminance parameters of the illumination apparatus 12 among the image capturing environment data.

Furthermore, the initial image capturing environment setting unit 23 sets each parameter of the image capturing apparatus 11 and the illumination apparatus 12 so as to be the same as the environmental parameters obtained from the reference camera image DB 21. That is, the initial image capturing environment setting unit 23 sets the same image capturing environment as that of the image capturing environment IDr as an initial image capturing environment.

Furthermore, the initial image capturing environment setting unit 23 secures a new recording area for registering the image capturing environment data of the current image capturing environment in the reference camera image DB 21, and sets this image capturing environment ID as an image capturing environment IDx. The initial image capturing environment setting unit 23 supplies the image capturing environment IDr to the image capturing environment adjustment unit 24.

The image capturing environment adjustment unit 24 obtains camera images of all the image capturing apparatuses 11 stored in the image capturing environment IDr as reference images from the reference camera image DB 21 on the basis of the image capturing environment IDr supplied from the initial image capturing environment setting unit 23.

Furthermore, each image capturing apparatus 11 captures an image of the subject, and the image capturing environment adjustment unit 24 compares the captured image obtained as a result of the image capturing, and the camera image obtained as the reference image from the reference camera image DB 21, and adjusts the camera parameters of the image capturing apparatus 11 for the number of the image capturing apparatuses 11. The image capturing environment adjustment unit 24 supplies the image capturing environment IDr to the image capturing environment registration unit 25.

The image capturing environment registration unit 25 obtains the camera parameters of the final state after the image capturing environment adjustment unit 24 performs the adjustment, and the captured image, and stores (registers) the obtained camera parameters and captured image in the reference camera image DB 21. Specifically, the image capturing environment registration unit 25 estimates the internal parameters and the external parameters of the image capturing apparatus 11 in the final state after the adjustment is performed, captures the image of the subject, and obtains the captured image. Then, the image capturing environment registration unit 25 stores the camera parameters and the captured image in the recording area of the image capturing environment IDx in the reference camera image DB 21 secured for the image capturing environment data of the current image capturing environment. The captured image obtained by capturing an image of the subject is stored as a reference camera image.

The image processing system 10 according to the first embodiment is configured as described above.

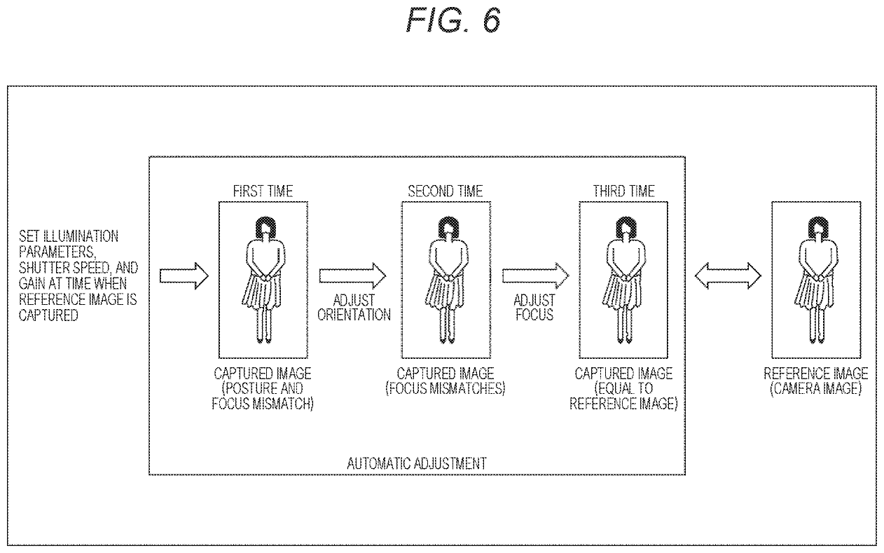

FIG. 6 is a view simply illustrating a flow of image capturing environment adjustment processing executed by the image processing apparatus 13 according to the first embodiment.

First, the image processing apparatus 13 sets the illumination parameters of the illumination apparatus 12 and the shutter speed and the gain of the image capturing apparatus 11 that are numerically settable parameters among the environmental parameters of the image capturing environment IDr selected by the user, then performs first image capturing, and obtains the captured image.

Comparing the captured image obtained by the first image capturing with a camera image of the same image capturing position as that of the image capturing environment IDr, the posture and the focus of the image capturing apparatus 11 do not match.

Therefore, the image processing apparatus 13 detects and adjusts (controls) the mismatch of the posture of the image capturing apparatus 11 by using the captured image of the first image capturing, then performs second image capturing, and obtains the captured image. The mismatch of the posture described herein corresponds to a mismatch of yaw and pitch since it is assumed that roll is not changed.

In the captured image obtained by the second image capturing, the posture of the image capturing apparatus 11 matches, yet the focus still mismatches.

Then, the image processing apparatus 13 detects and adjusts (controls) the mismatch of the focus of the image capturing apparatus 11 by using the captured image of the second image capturing, then performs third image capturing, and obtains the captured image. The captured image of the third image capturing is equivalent to the camera image of the same image capturing position. as that of the image capturing environment IDr.

As described above, the image capturing environment adjustment unit 24 of the image processing apparatus 13 adjusts the camera parameters on the basis of a comparison result obtained by comparing camera images obtained by capturing images of a predetermined subject at past times that are different timings as the reference image with the captured image obtained by capturing the image of the same subject in the current environment.

### 4. Processing of Image Processing System According to First Embodiment

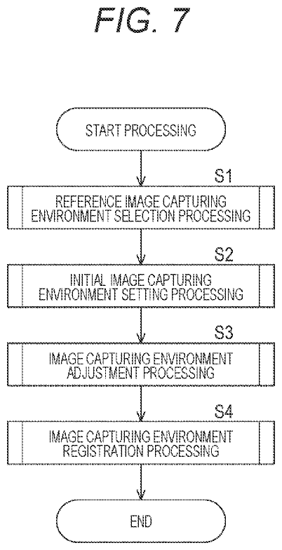

FIG. 7 is a flowchart illustrating processing of the entire image processing system 10 according to the first embodiment. This processing is started when, for example, an unillustrated operation unit of the image processing apparatus 13 performs an operation of instructing starting adjustment of the image capturing environment.

In step S1, the reference image capturing environment selection unit 22 first executes reference image capturing environment selection processing of causing the user to select a past image capturing environment to be referred to for current image capturing from the image capturing environment list stored in the reference camera image DB 21.

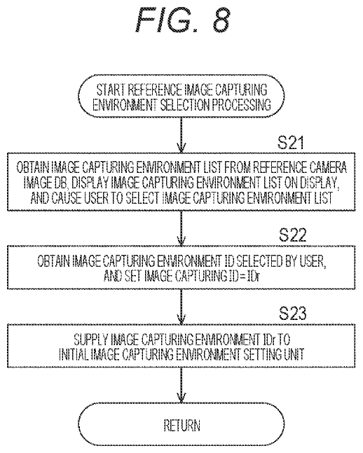

FIG. 8 is a flowchart illustrating details of reference image capturing environment selection processing executed in step S1 in FIG. 7.

According to the reference image capturing environment selection processing, in step S21, the reference image capturing environment selection unit 22 first obtains the image capturing environment list that is a list of image capturing environment data from the reference camera image DB 21, displays the image capturing environment list on the display, and causes the user to select the image capturing environment. For example, the user performs an operation of specifying an image capturing environment ID whose image capturing environment needs to be matched for the current image capturing.

In step S22, the reference image capturing environment selection unit 22 obtains the image capturing environment ID selected by the user, and sets the image capturing environment ID as the image capturing environment IDr to be referred to for the current image capturing.

In step S23, the reference image capturing environment selection unit 22 supplies the image capturing environment IDr to the initial image capturing environment setting unit 23.

The reference image capturing environment selection processing ends as described above, and the processing returns to FIG. 7 and proceeds to step S2.

In step S2 in FIG. 7, the initial image capturing environment setting unit 23 executes initial image capturing environment setting processing of setting the same image capturing environment as that of the image capturing environment IDr supplied from the reference image capturing environment selection unit 22 as an initial image capturing environment.

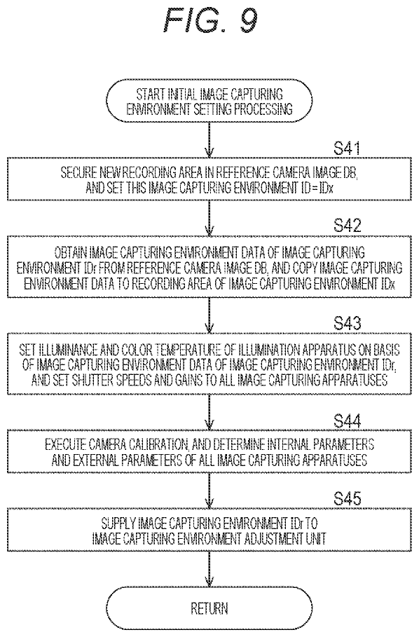

FIG. 9 is a flowchart illustrating details of initial image capturing environment setting processing executed in step S2 in FIG. 7.

According to the initial image capturing environment setting processing, in step S41, the initial image capturing environment setting unit 23 first secures a new recording area for registering the image capturing environment data of the current image capturing environment in the reference camera image DB 21, and sets the image capturing environment ID as the image capturing environment IDx.

In step S42, the image capturing environment setting unit 23 obtains the image capturing environment data of the image capturing environment IDr from the reference camera image DB 21, and copies the image capturing environment data to the recording area of the image capturing environment IDx. Note that the current date is recorded as the image capturing date of the image capturing environment IDx.

In step S43, the initial image capturing environment setting unit 23 sets the illuminance and the color temperature of the illumination apparatus 12 on the basis of the image capturing environment data of the image capturing environment IDr obtained from the reference image capturing environment selection unit 22, and sets shutter speeds and gains for all the image capturing apparatuses 11.

In step S44, the initial image capturing environment setting unit 23 executes camera calibration, and determines (estimates) the internal parameters and the external parameters of all the image capturing apparatuses 11. Camera calibration is, for example, processing of capturing an image of a known calibration pattern such as a chessboard, and determining (estimating) the internal parameters and the external parameters from the captured image.

In step S45, the initial image capturing environment setting unit 23 supplies the image capturing environment IDr to the image capturing environment adjustment unit 24.

The initial image capturing environment setting processing ends as described above, and the processing returns to FIG. 7 and proceeds to step S3.

In step S3 in FIG. 7, the image capturing environment adjustment unit 24 executes image capturing environment adjustment processing of adjusting the camera parameters of each image capturing apparatus 11 by comparing the captured image obtained by capturing an image of the subject by each image capturing apparatus 11 with the camera image of the image capturing environment IDr as the reference image.

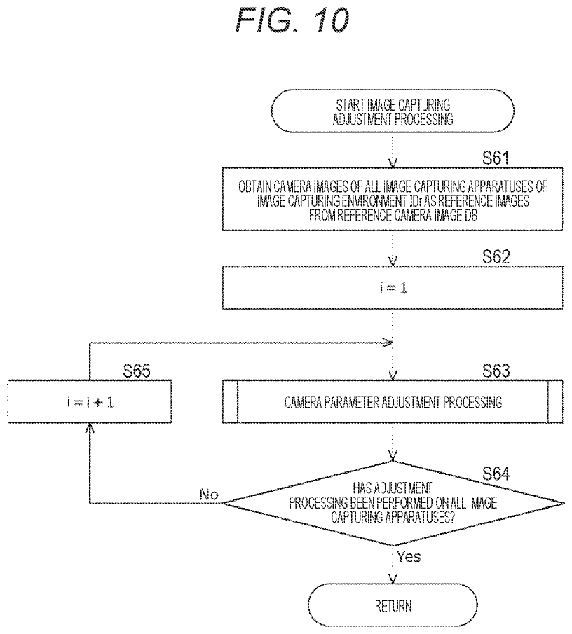

FIG. 10 is a flowchart illustrating details of the image capturing environment adjustment processing executed in step S3 in FIG. 7.

According to the image capturing environment adjustment processing, in step S61, the image capturing environment adjustment unit 24 first obtains the camera images of all the image capturing apparatuses 11 stored in the image capturing environment IDr as the reference images from the reference camera image DB 21 on the basis of the image capturing environment IDr supplied from the initial image capturing environment setting unit 23.

In step S62, the image capturing environment adjustment unit 24 sets 1 as an initial value to a variable i that specifies the predetermined image capturing apparatus 11 among the N image capturing apparatuses 11.

In step S63, the image capturing environment adjustment unit 24 executes camera parameter adjustment processing of adjusting a posture (yaw and pitch) and a focus of the i-th image capturing apparatus 11 by comparing the captured image captured by the i-th image capturing apparatus 11, and the corresponding camera image obtained as the reference image from the image capturing environment IDr.

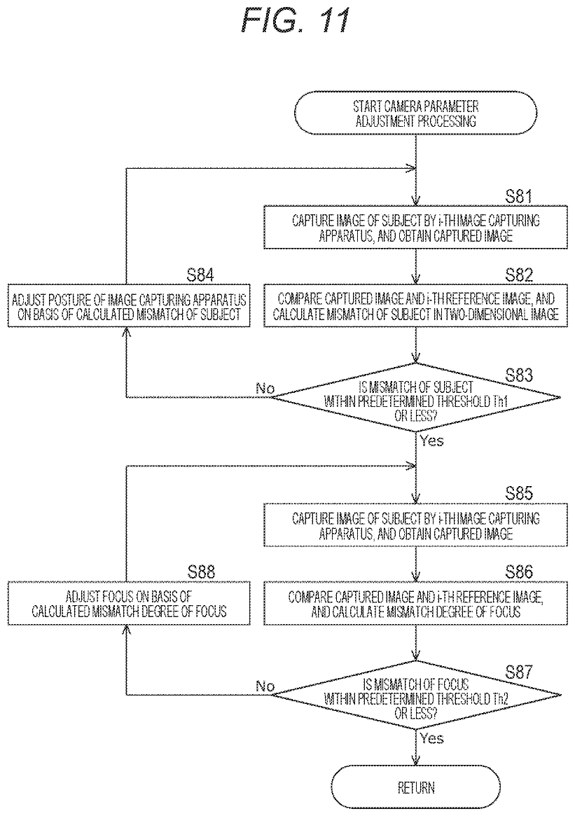

FIG. 11 is a flowchart illustrating details of the camera parameter adjustment processing executed in step S63 in FIG. 10.

According to the camera parameter adjustment processing, in step S81, the i-th image capturing apparatus 11 first captures an image of the subject, and the image capturing environment adjustment unit 24 obtains the captured image. The subject whose image is captured here is an object such as a mannequin whose conditions do not change, and is the same object as the subject appearing in the camera image of the image capturing environment IDr.

Subsequently, in step S82, the image capturing environment adjustment unit 24 compares the obtained captured image, and the camera image that is an i-th reference image, and calculates a mismatch of the subject in two-dimensional image. For example, the image capturing environment adjustment unit 24 calculates an optical flow for searching from where to where corresponding points (predetermined portions of the subject) of the two images have moved, and calculates the mismatch of the subject from a magnitude of a vector.

In step S83, the image capturing environment adjustment unit 24 determines whether or not the calculated mismatch of the subject is within a predetermined threshold Th1.

In a case where it is determined in step S83 that the calculated mismatch or the subject is not within the predetermined threshold Th1 (the calculated mismatch is larger than the predetermined threshold Th1), the processing proceeds to step S84, and the image capturing environment adjustment unit 24 adjusts the posture of the i-th image capturing apparatus 11 on the basis of the calculated mismatch of the subject. For example, a control command for correcting a mismatch of yaw and pitch of the i-th image capturing apparatus 11 is transmitted to the i-th image capturing apparatus 11.

After step S84, the processing returns to step S81, and above-described steps S81 to S83 are executed again.

On the other hand, in a case where it is determined in step S83 that the calculated mismatch of the subject is within the predetermined threshold Th1, the processing proceeds to step S85, the i-th image capturing apparatus 11 captures an image of the subject, and the image capturing environment adjustment unit 24 obtains the captured image.

Subsequently, in step S86, the image capturing environment adjustment unit 24 compares the captured image with the camera image that is the i-th reference image, and calculates the mismatch degree of the focus (focus position). For example, the image capturing environment adjustment unit 24 calculates a difference between frequency components of the two respective images as the mismatch degree of focus, or calculates a difference between differential images of the two respective images as the mismatch degree of focus. The mismatch degree of focus may be converted into numerical values by some method and compared.

In step S87, the image capturing environment adjustment unit 24 determines whether or not the calculated mismatch degree of focus is within a predetermined threshold Th2.

In a case where it is determined in step S87 that the calculated mismatch degree of focus is not within the predetermined threshold Th2 (the calculated mismatch degree of focus is larger than the predetermined threshold Th2), the processing proceeds to step S88, and the image capturing environment adjustment unit 24 adjusts the focus on the basis of the calculated mismatch degree of focus. For example, a control command for correcting a focus position of the i-th image capturing apparatus 11 is transmitted to the i-th image capturing apparatus 11.

On the other hand, in a case where it is determined in step S87 that the calculated mismatch degree of focus is within the predetermined threshold Th2, the camera parameter adjustment processing ends, and the processing returns to FIG. 10 and proceeds to step 564.

In step S64, the image capturing environment adjustment unit 24 determines whether or not the camera parameter adjustment processing has been performed on all the image capturing apparatuses 11, that is, the N image capturing apparatuses 11.

In a case where it is determined in step S64 that the camera parameter adjustment processing has not yet been performed on all the image capturing apparatuses 11, the processing proceeds to step S65, and the image capturing environment adjustment unit 24 increments the variable i by 1, and then returns the processing to step S63. Therefore, the camera parameter adjustment processing for the next image capturing apparatus 11 is executed.

On the other hand, in a case where it is determined in step S64 that the camera parameter adjustment processing has been performed on all the image capturing apparatuses 11, the image capturing environment adjustment processing ends, and the processing returns to FIG. 7 and proceeds to step S4.

In step S4 in FIG. 7, the image capturing environment registration unit 25 executes image capturing environment registration processing of registering in the reference camera image DB 21 the image capturing environment data of the final state after the image capturing environment adjustment unit 24 performs the adjustment.

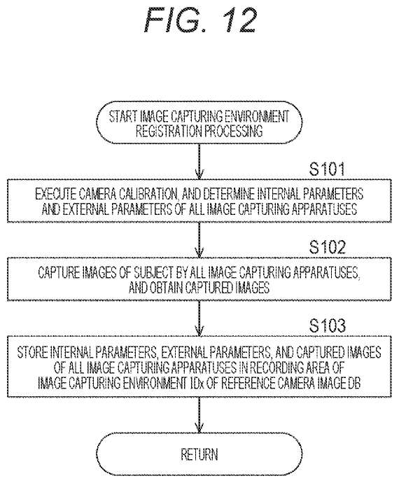

FIG. 12 is a flowchart illustrating details of the image capturing environment registration processing executed in step S4 in FIG. 7.

According to the image capturing environment registration processing, in step S101, the image capturing environment registration unit 25 first executes camera calibration, and determines (estimates) the internal parameters and the external parameters of all the image capturing apparatuses 11. This processing is similar to the processing executed in step S44 of the initial image capturing environment setting processing in FIG. 9.

Subsequently, in step S102, all the image capturing apparatuses 11 capture the images of the subject, and the image capturing environment registration unit 25 obtains the captured images.

In step S103, the image capturing environment registration unit 25 stores the internal parameters, the external parameters and the captured images of all the image capturing apparatuses 11 in a recording area of the image capturing environment IDx in the reference camera image DB 21. The illuminance and the color temperature of the other illumination apparatus 12, the image capturing apparatus arrangement IDs, the number of image capturing apparatuses 11, the shutter speeds, and the gains have already been stored by the processing in step S42 of the image capturing environment setting processing in FIG. 9.

The image capturing environment registration processing ends as described above, the processing returns to FIG. 7, and the processing in FIG. 7 itself also ends.

According to the first embodiment of the image processing system 10 that executes the above-described adjustment processing, under the conditions that the three-dimensional position and roll of the image capturing apparatus 11 have not changed, the image processing apparatus 13 can automatically match the illumination parameters (the illuminance and the color temperature) of each illumination apparatus 12, and the posture (yaw and pitch), the focus (focus position), the shutter speed, and the gain of each image capturing apparatus 11 with those of past image capturing environment. Therefore, as compared with a conventional method where the user manually adjusts the captured image while viewing the captured image, it is possible to easily adjust image capturing environment, and reduce operation cost.

### 5. Second Embodiment of Image Processing System

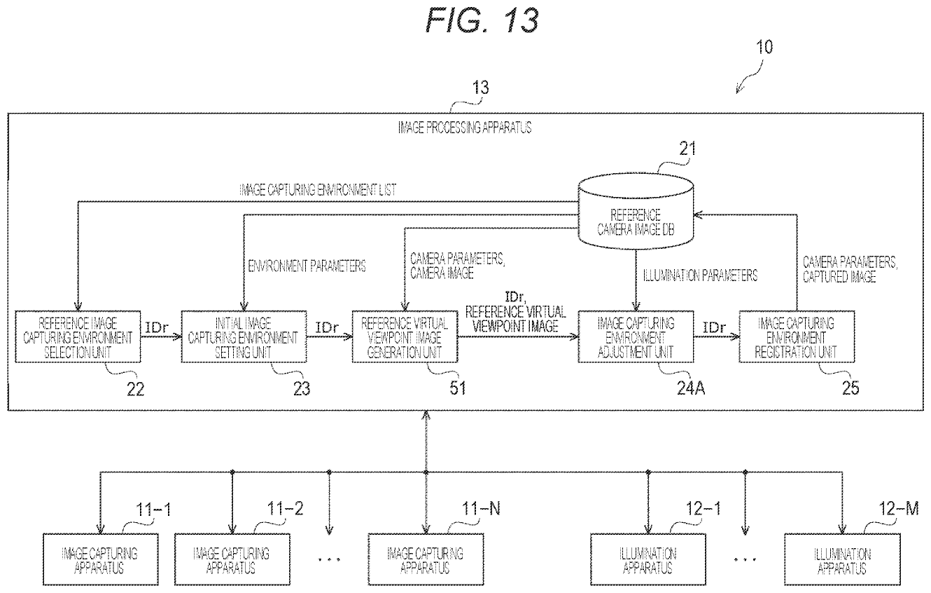

FIG. 13 is a block diagram illustrating a second embodiment of an image processing system to which the present disclosure is applied.

In the second embodiment in FIG. 13, components corresponding to those of the first embodiment illustrated in FIG. 4 will be assigned the same reference numerals, and description of the components will be appropriately omitted.

An image processing system 10 in FIG. 13 includes N image capturing apparatuses 11-1 to 11-N, N illumination apparatuses 12-1 to 12-M, and an image processing apparatus 13.

Although the above-described first embodiment employs a configuration where, in a case where a three-dimensional position and roll of the current image capturing apparatus 11 have not changed, current image capturing environment is matched with past image capturing environment, the second embodiment employs a configuration that supports a case where the three-dimensional position and roll of the image capturing apparatus 11 also change. For example, there is assumed a case where arrangement of the N image capturing apparatuses 11-1 to 11-N is changed, a case where an image capturing studio (image capturing space) is different, or the like.

The image processing apparatus 13 includes a reference camera image DB 21, a reference image capturing environment selection unit 22, an initial image capturing environment setting unit 23, a reference virtual viewpoint image generation unit 51, an image capturing environment adjustment unit 24A, and an image capturing environment registration unit 25.

Therefore, upon comparison with the first embodiment, in the image processing apparatus 13 of the second embodiment, the reference virtual viewpoint image generation unit 51 is newly added, and an image capturing environment adjustment unit 24 is changed to the image capturing environment adjustment unit 24A. Other components of the image processing apparatus 13 are similar to those of the first embodiment.

The reference virtual viewpoint image generation unit 51 obtains an image capturing environment IDr from the initial image capturing environment setting unit 23. Furthermore, the reference virtual viewpoint image generation unit 51 generates a 3D model of a subject by using internal parameters, external parameters and die camera image of each of the image capturing apparatuses 1 to N stored in the image capturing environment IDr. Furthermore, the reference virtual viewpoint image generation unit 51 generates, as a reference virtual viewpoint image, a virtual viewpoint image that views the generated 3D model of the subject from the same viewpoint as that of each current image capturing apparatus 11, and supplies the reference virtual viewpoint image together with the image capturing environment IDr to the image capturing environment adjustment unit 24A.

The image capturing environment adjustment unit 24A obtains illumination parameters (an illuminance and a color temperature) stored in the image capturing environment IDr from the reference camera image DB 21 on the basis of the image capturing environment IDr supplied from the reference virtual viewpoint image generation unit 51. Furthermore, the image capturing environment adjustment unit 24A adjusts setting values of the illumination apparatus 12 to the illuminance and the color temperature of The image capturing environment IDr. Furthermore, the image capturing environment adjustment unit 24A compares a reference virtual viewpoint image supplied from the reference virtual viewpoint image generation unit 51 and corresponding to each of the image capturing apparatus 11, and the captured image captured by the image capturing apparatus 11, and adjusts camera parameters of the image capturing apparatus 11.

The image processing system 10 according to the second embodiment is configured as described above.

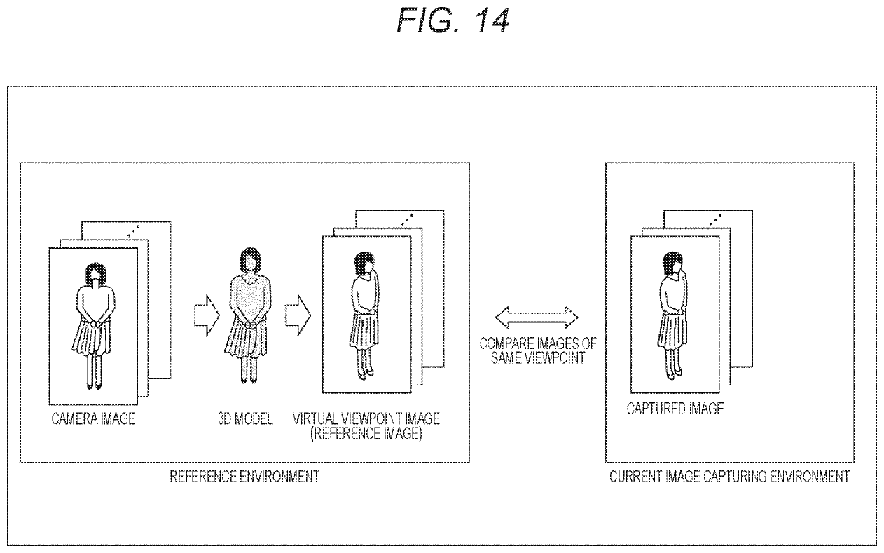

FIG. 14 is a view for explaining image capturing environment adjustment processing executed by the image capturing environment adjustment unit 24A according to the second embodiment.

The second embodiment assumes that the arrangement of the image capturing apparatus 11 is different from arrangement at a time of past image capturing, and therefore assumes that a viewpoint of a camera image of the image capturing environment IDr obtained from the reference camera image DB 21 is different from a viewpoint of the image capturing apparatus 11. Therefore, first, it is necessary to match the viewpoint of the reference image and the viewpoint of the image capturing apparatus 11.

Therefore, the reference virtual viewpoint image generation unit 51 generates a 3D model of the subject from the internal parameters, the external parameters and the camera image of each of the image capturing apparatuses 1 to N of the image capturing environment IDr obtained from the reference camera image DB 21, and generates as a reference image a virtual viewpoint image that views the generated 3D model from the viewpoint of each image capturing apparatus 11 that is a current environment. Therefore, the generated virtual viewpoint image is an image that has the same viewpoint as that of one of the current image capturing apparatuses 11, so that the image capturing environment adjustment unit 24 A can compare the generated virtual viewpoint image and the captured image obtained by capturing the image of the subject by the image capturing apparatus 11 having the same viewpoint as that of the generated virtual viewpoint image, and adjust the camera parameters on the basis of the comparison. result.

Furthermore, the second embodiment assumes that a difference in arrangement of the image capturing apparatuses 11 produces a difference in a brightness, and therefore the image capturing environment adjustment unit 24A adjusts illumination parameters, too. Other adjustment of the image capturing environment adjustment unit 24A is similar to that of the image capturing environment adjustment unit 24 according to the first embodiment.

### 6. Processing of Image Processing System According to Second Embodiment

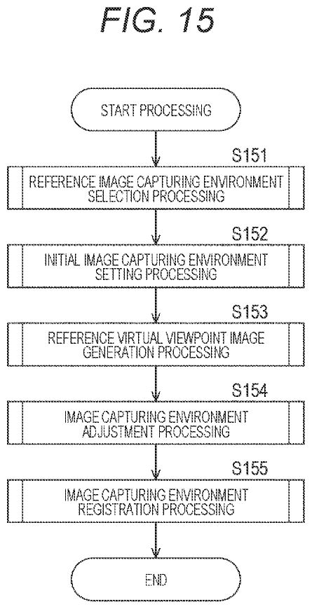

FIG. 15 is a flowchart illustrating processing of the entire image processing system 10 according to the second embodiment. This processing is started when, for example, an unillustrated operation unit of the image processing apparatus 13 performs an operation of instructing starting adjustment of the image capturing environment.

First, in step S151, the reference image capturing environment selection unit 22 executes reference image capturing environment selection processing of causing the user to select a past image capturing environment to be referred to for current image capturing from the image capturing environment list stored in the reference camera image DB 21. Details of this processing are similar to those of the processing described with reference to the flowchart in FIG. 8.

In step S152, the initial image capturing environment setting unit 23 executes initial image capturing environment setting processing of setting the same image capturing environment as that of the image capturing environment IDr supplied from the reference image capturing environment selection unit 22 as an initial image capturing environment. Details of this processing are similar to those of the processing described with reference to the flowchart in FIG. 9.

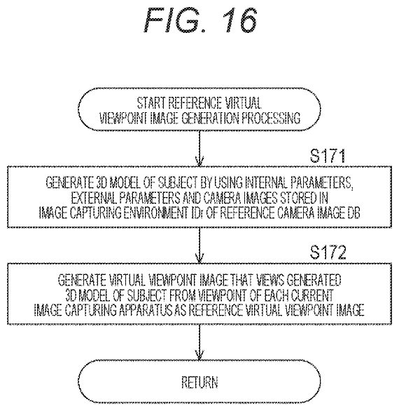

In step S153, the reference virtual viewpoint image generation unit 51 executes reference virtual viewpoint image generation processing of generating a 3D model from image capturing environment data stored in the image capturing environment IDr, and generating a virtual viewpoint image obtained that views the generated 3D model from a viewpoint of each current image capturing apparatus 11 as a reference virtual viewpoint image. Details of this processing will be described later with reference to FIG. 16.

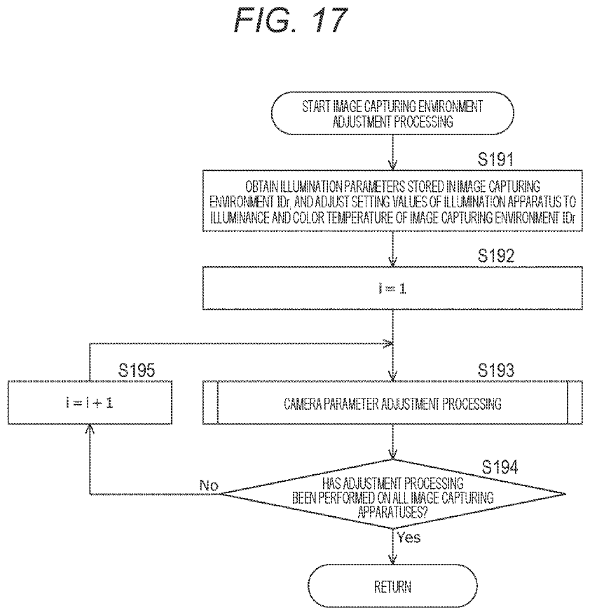

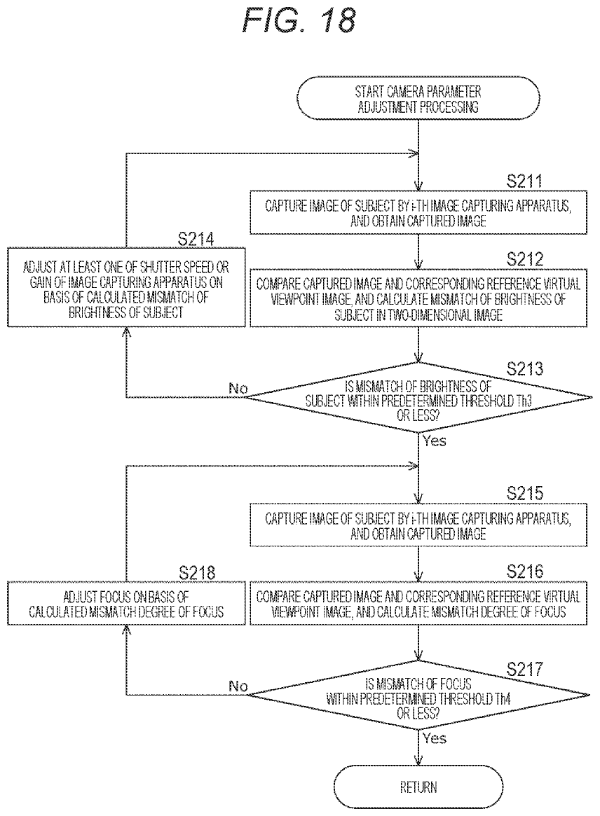

In step S154, the image capturing environment adjustment unit 241 executes image capturing environment adjustment processing of adjusting the camera parameters of each image capturing apparatus 11 by comparing the captured image obtained by capturing an image of the subject by each image capturing apparatus 11 with the reference virtual viewpoint image of the image capturing environment IDr as the reference image. Details of this processing will be described later with reference to FIGS. 17 and 18.

In step S155, the image capturing environment registration unit 25 executes image capturing environment registration processing or registering in the reference camera image DB 21 the image capturing environment data of a final state after the image capturing environment adjustment unit 24 performs the adjustment.

FIG. 16 is a flowchart illustrating details of the reference virtual viewpoint image generation processing executed in step S153 in FIG. 15.

In step S171, the reference virtual viewpoint image generation unit 51 first generates a 3D model of a subject by using the internal parameters, the external parameters and the camera image of each of the image capturing apparatuses 1 to N stored in the image capturing environment IDr supplied from the image capturing environment setting unit 23.

In step S172, the reference virtual viewpoint image generation unit 51 generates, as a reference virtual viewpoint image, a virtual viewpoint image that views the generated 3D model of the subject from the viewpoint of each current image capturing apparatus 11, and supplies the reference virtual viewpoint image together with the image capturing environment IDr to the image capturing environment adjustment unit 24A.

The reference virtual viewpoint image generation processing ends as described above, and the processing returns to FIG. 15 and proceeds to step S154.

FIG. 17 is a flowchart illustrating details of the image capturing environment adjustment processing executed in step S154 in FIG. 15.

In step S191, the image capturing environment adjustment unit 24A first obtains illumination parameters (an illuminance and a color temperature) stored in the image capturing environment IDr from the reference camera image DB 21 on the basis of the image capturing environment IDr supplied from the reference virtual viewpoint image generation unit 51, and adjusts setting values of the illumination apparatus 12 to the illuminance and the color temperature of the image capturing environment IDr.

In step S192, the image capturing environment adjustment unit 24A sets 1 as an initial value to a variable i that specifies the predetermined image capturing apparatus 11 among the N image capturing apparatuses 11.

In step S193, the image capturing environment adjustment unit 24A executes camera parameter adjustment processing of adjusting the camera parameters of an i-th image capturing apparatus 11 by comparing the captured image captured by the i-th image capturing apparatus 11, and a corresponding reference virtual viewpoint image generated by the reference virtual viewpoint image generation unit 51. Details of this processing will be described later with reference to FIG. 18.

In step S194, the image capturing environment adjustment unit 24A determines whether or not the camera parameter adjustment processing has been performed on all the image capturing apparatuses 11, that is, the N image capturing apparatuses 11.

In a case where it is determined in step S194 that the camera parameter adjustment processing has not been performed on all the image capturing apparatuses 11, the processing proceeds to step S195, and the image capturing environment adjustment unit 24A increments the variable i by 1, and then returns the processing to step S193. Therefore, the camera parameter adjustment processing for the next image capturing apparatus 11 is executed.

On the other hand, in a case where it is determined in step S194 that the camera parameter adjustment processing has been performed on all the image capturing apparatuses 11, the image capturing environment adjustment processing ends, and the processing returns to FIG. 15 and proceeds to step S155.

FIG. 18 as a flowchart illustrating details of the camera parameter adjustment processing executed an step S193 in FIG. 17.

According to the camera parameter adjustment processing, in step S211, the i-th image capturing apparatus 11 first captures an image of the subject, and the image capturing environment adjustment unit 24A obtains the captured images. The subject whose image is captured here is an object such as a mannequin whose conditions do not change, and is the same object as the subject appearing in the camera image of the image capturing environment IDr.

Subsequently, in step S212, the image capturing environment adjustment unit 24A compares the obtained captured image, and the corresponding reference virtual viewpoint image, and calculates a mismatch of a brightness of the subject in the two-dimensional image. For example, the image capturing environment adjustment unit 24A calculates a difference between luminance values converted from RGB values of the corresponding points (predetermined portions of the subject) of the two images as the mismatch of the brightness.

In step S213, the image capturing environment adjustment unit 24A determines whether or not the calculated mismatch of the brightness of the subject within a predetermined threshold Th3.

In a case where it is determined in step S213 that the calculated mismatch of the brightness of the subject is not within the predetermined threshold Th3 (the calculated mismatch of the brightness is larger than the predetermined threshold Th3), the processing proceeds to step S214, and the image capturing environment adjustment unit 24A adjusts at least one of the shutter speed or the gain of the i-th image capturing apparatus 11 on the basis of the calculated mismatch of the brightness of the subject. For example, a control command for changing a gain of the i-th image capturing apparatus 11 is transmitted to the i-th image capturing apparatus 11.

After step S214, the processing returns to step S211, and above-described steps S211 to S213 are executed again.

On the other hand, in a case where it is determined in step S213 that the calculated mismatch of the brightness of the subject is within the predetermined threshold Th3, the processing proceeds to step S215, the i-th image capturing apparatus 11 captures an image of the subject, and the image capturing environment adjustment unit 24A obtains the captured image.

Subsequently, in step S216, the image capturing environment adjustment unit 24A compares the obtained captured image, and the corresponding reference virtual viewpoint image, and calculates the mismatch degree of the focus (focus position). This processing is similar to step S86 in FIG. 11 according to the first embodiment.

In step S217, the image capturing environment adjustment unit 24A determines whether or not the calculated mismatch degree of focus is within a predetermined threshold Th4.

In a case where it is determined in step S217 that the calculated mismatch degree of focus is not within the predetermined threshold Th4, the processing proceeds to step S218, and the image capturing environment adjustment unit 24A adjusts the focus on the basis of the calculated mismatch degree of focus. This processing is similar to step S88 in FIG. 11 according to the first embodiment.

On the other hand, in a case where it is determined in step S217 that the calculated mismatch degree of focus is within the predetermined threshold Th4, the camera parameter adjustment processing ends, and the processing returns to FIG. 17 and proceeds to step S194.

Processing of the image processing system 10 according to the second embodiment is executed as described above.

According to the second embodiment of the image processing system 10, even in a case where, for example, the three-dimensional position of the image capturing apparatus 11 is changed, the image processing apparatus 13 can automatically match the illumination parameters (the illuminance and the color temperature) of each illumination apparatus 12, and the focus (focus position), the shutter speed, and the gain of each image capturing apparatus 11 with those of past image capturing environment. Therefore, as compared with a conventional method where the user manually adjusts the captured image while viewing the captured image, it is possible to easily adjust image capturing environment, and reduce operation cost.

The image processing apparatus 13 includes both the above-described configuration according to the first embodiment and configuration according to the second embodiment, and can select and execute one of the adjustment processing by specifying, for example, whether or not the three-dimensional position of the current image capturing apparatus 11 is the same as that of the past image capturing environment to be matched.

### 7. Configuration of 3D Model Playback Display Apparatus

The image processing apparatus 13 of the image processing system 10 includes a function as a 3D model playback display apparatus, too, that performs not only processing of adjusting an image capturing environment, but also processing of controlling the image capturing apparatus 11 and the illumination apparatus 12 after the image capturing environment is adjusted, capturing an image of a subject that is a 3D model generation target that is not for adjustment, obtaining moving image data, and generating a 3D model, and display processing of generating a virtual viewpoint image that views the generated 3D model viewed from an arbitrary virtual viewpoint, and causing a predetermined display apparatus to display the virtual viewpoint image.

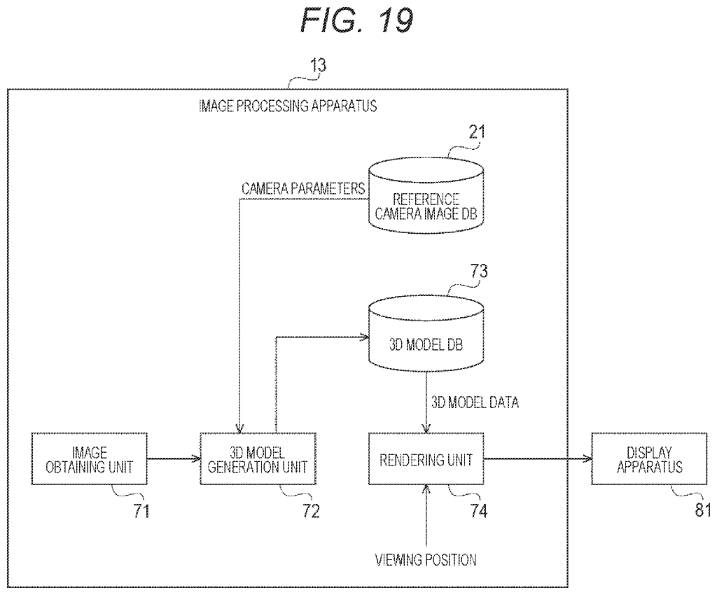

FIG. 19 is a block diagram illustrating a configuration example in a case where the image processing apparatus 13 executes the function as the 3D model playback display apparatus.

The image processing apparatus 13 includes an image obtaining unit 71, a 3D model generation unit 72, a 3D model DB 73, a rendering unit 74, and a reference camera image DB 21.

The image obtaining unit 71 obtains captured images (moving images) obtained by capturing images of the subject and supplied from each of the N image capturing apparatuses 11-1 to 11-N, and supplies the captured images to the 3D model generation. unit 72.

The 3D model generation unit 72 obtains the camera parameters of the image capturing apparatuses 1 to N in the current image capturing environment from the reference camera image DB 21. The camera parameters include at least the external parameters and the internal parameters.

The 3D model generation unit 72 generates a 3D model of the subject on the basis of the captured images captured by the N image capturing apparatuses 11-1 to 11-N and the camera parameters, and causes the 3D model DB 73 to store moving image data (3D model data) of the generated 3D model.

The 3D model DB 73 stores the 3D model data generated by the 3D model generation unit 72, and supplies the 3D model data to the rendering unit 74 in response to a request from the rendering unit 74. The 3D model DB 73 and the reference camera image DB 21 may be the same storage medium or may be separate storage media.

The rendering unit 74 obtains, from The 3D model DB 73, moving image data (3D model data) of a 3D model specified by the viewer who views a playback image of the 3D model. Then, the rendering unit 74 generates (plays back) a two-dimensional image that views the 3D model from a viewing position of the viewer supplied from the unillustrated operation unit, and supplies the two-dimensional image to the display apparatus 81. The rendering unit 74 assumes a virtual camera whose image capturing range is a viewing range of the viewer, generates a two-dimensional image of a 3D object captured by the virtual camera, and causes the display apparatus 81 to display the two-dimensional image. The display apparatus 81 includes a display D1 as illustrated in FIG. 1, a head mounted display (HMD) D2, and the like.

### 8. Computer Configuration Example

The above-described series of processing can be executed by hardware or can be executed by software. In a case where the series of processing is executed by software, a program that configures this software is installed to a computer. Here, the computer includes, for example, a microcomputer incorporated in dedicated hardware, and a general-purpose personal computer that can execute various functions by installing various programs.

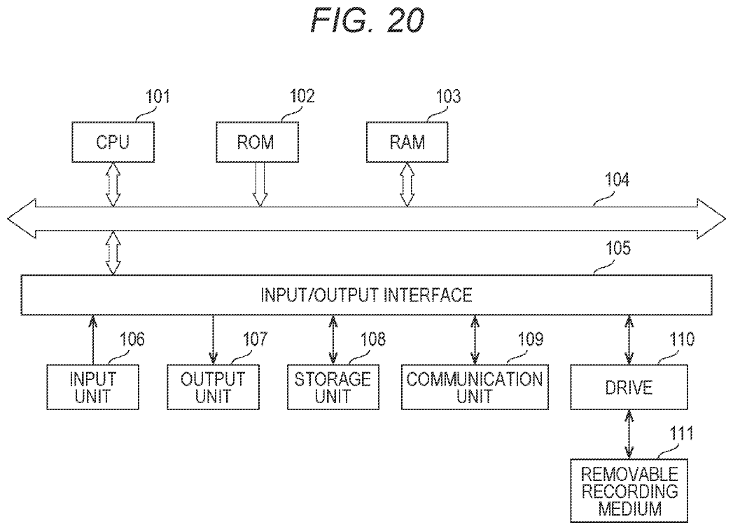

FIG. 20 is a block diagram illustrating a configuration example of hardware of the computer that executes the above-described series of processing by the program.

In the computer, a central processing unit (CPU) 101, a read only memory (ROM) 102, and a random access memory (RAM) 103 are mutually connected by a bus 104.

The bus 104 is further connected with an input/output interface 105. The input/output interface 105 is connected with an input unit 106, an output unit 107, a storage unit 108, a communication unit 109, and a drive 110.

The input, unit 106 includes a keyboard, a mouse, a microphone, a touch panel, an input terminal, and the like. The output unit 107 includes a display, a speaker, an output terminal, and the like. The storage unit 108 includes a hard disk, a RAM disk, a nonvolatile memory, and the like. The communication unit 109 includes a network interface and the like. The drive 110 drives a removable recording medium 111 such as a magnetic disk, an optical disk, a magneto-optical disk, or a semiconductor memory.

The computer configured as described above, for example, the CPU 101 loads a program stored in the storage unit 108 into the RAM 103 via the input/output interface 105 and the bus 104, executes the program, and thereby performs the above-described series of processing. The RAM 103 also appropriately stores data and the like that is necessary for the CPU 101 to execute various types of processing.

The program executed by the computer (CPU 101) can be recorded in the removable recording medium 111 as a package medium or the like, and provided. Furthermore, the program can be provided via a wired or wireless transmission medium such as a local area network, the Internet, or digital satellite broadcasting.

In this description, the steps described in the flowcharts are naturally performed in chronological order in the described order, may not be necessarily processed in chronological order, or may be executed in parallel or at necessary timing such as a time when invoked.

In this description, a system means a set of a plurality of components (e.g., apparatuses and modules (parts)), and whether or not all components are in the same housing does not matter. Therefore, a plurality of apparatuses housed in separate housings and connected via a network and one apparatus in which a plurality of modules is housed in one housing are each the system.

The embodiments of the present disclosure are not limited to the above-described embodiments, and various modifications can be made without departing from the gist of the present disclosure.

For example, an aspect obtained by combining all or part of a plurality of above-described embodiments can be adopted.

For example, the present disclosure can employ a configuration of cloud computing where one function is shared and processed in cooperation by a plurality of apparatuses via a network.

Furthermore, each step described with reference to the above-described flowchart can be executed by one apparatus and, in addition, can be shared and executed by a plurality of apparatuses.

Furthermore, in a case where one step includes a plurality of processing, a plurality of processing included in this one step can be executed by one apparatus and, in addition, can be shared and executed by a plurality of apparatuses.

Note that the effects described in this description are merely examples and are not limited, and may be effects other than those described in this description.

Note that the present disclosure can employ following configurations.

(1)

An image processing apparatus including

an adjustment unit that adjusts camera parameters on the basis of a comparison result between a reference image based on images obtained by capturing images of a predetermined subject at different timings, and a captured image obtained by capturing an image of the same subject in a current environment.

(2)

The image processing apparatus described in (1),

in which the adjustment unit compares the images obtained by capturing the images of the predetermined subject at the different timings as the reference image with the captured image, and adjusts the camera parameters.

(3)

The image processing apparatus described in (1) or (2), further including

a reference image generation unit that generates a 3D model of the subject from a plurality of the images obtained by capturing the images of the predetermined subject at the different timings, and generates a virtual viewpoint image that views the generated 3D model from a viewpoint of the current environment as the reference image,

in which the adjustment unit compares the virtual viewpoint image as the reference image, and the captured image, and adjusts the camera parameters.

(4)

The image processing apparatus described in any one of (1) to (3) further including:

a storage unit that stores the images obtained by capturing the images of the predetermined subject at the different timings for one or more environments; and

a selection unit that causes a user to select one predetermined of the one or more environments stored in the storage unit,

in which the adjustment unit adjusts the camera parameters on the basis of a comparison result between a reference image based on the image of the environment selected by the user, and the captured image.

(5)

The image processing apparatus described in any one of (1) to (4),

in which the adjustment unit adjusts at least a shutter speed and a gain as the camera parameters.

(6)

The image processing apparatus described in any one of (1) to (5),

in which the adjustment unit adjusts at least an internal parameter and an external parameter of an image capturing apparatus as the camera parameters.

(7)

The image processing apparatus described in any one of (1) to (6),

in which the adjustment unit adjusts parameters of an illumination apparatus, too, in addition to the camera parameters.

(8)

The image processing apparatus described in (7),

in which the parameters of the illumination apparatus are an illuminance and a color temperature.

(9)

An image processing method including

adjusting camera parameters on the basis of a comparison result between a reference image based on images obtained by capturing images of a predetermined subject at different timings, and a captured image obtained by capturing an image of the same subject in a current environment.

(10)

A 3D model data generation method including

generating a 3D model of a second subject from a plurality of second captured images, and generating a virtual viewpoint image that views the generated 3D model of the second subject from a predetermined viewpoint, the plurality of second captured images being obtained by capturing images of the second subject by a plurality of image capturing apparatuses that use camera parameters adjusted on the basis of a comparison result between a reference image based on images obtained by capturing images of a first subject at different timings, and a first captured image obtained by capturing an image of the first subject in a current environment.

### REFERENCE SIGNS LIST

10 Image processing system
11-1 to 11-N Image capturing apparatus
12-1 to 12-M Illumination apparatus
13 Image processing apparatus
21 Reference camera image DB
22 Reference image capturing environment selection unit
23 Initial image capturing environment setting unit
24, 24A Image capturing environment adjustment unit
25 Image capturing environment registration unit
51 Reference virtual viewpoint image generation unit
71 Image obtaining unit
72 3D model generation unit
73 3D model DB
74 Rendering unit
81 Display apparatus
101 CPU
102 ROM
103 RAM
106 Input unit
107 Output unit
108 Storage unit
109 Communication unit
110 Drive

1. An image processing apparatus comprising
an adjustment unit that adjusts camera parameters on a basis of a comparison result between a reference image based on images obtained by capturing images of a predetermined subject at different timings, and a captured image obtained by capturing an image of the same subject in a current environment.

2. The image processing apparatus according to claim 1,
wherein the adjustment unit compares the images obtained by capturing the images of the predetermined subject at the different timings as the reference images with the captured image, and adjusts the camera parameters.

3. The image processing apparatus according to claim 1, further comprising
a reference image generation unit that generates a 3D model of the subject from a plurality of the images obtained by capturing the images of the predetermined subject at the different timings, and generates a virtual viewpoint image that views the generated 3D model from a viewpoint of the current environment as the reference image,
wherein the adjustment unit compares the virtual viewpoint image as the reference image, and the captured image, and adjusts the camera parameters.

4. The image processing apparatus according to claim 1, further comprising:
a storage unite, that stores the images obtained by capturing the images of the predetermined subject at the different timings for one or more environments; and
a selection unit that causes a user to select one predetermined of the one or more environments stored in the storage unit,
wherein the adjustment unit adjusts the camera parameters on a basis of a comparison result between a reference image based on the image of the environment selected by the user, and the captured image.

5. The image processing apparatus according to claim 1,
wherein the adjustment unit adjusts at least a shutter speed and a gain as the camera parameters.

6. The image processing apparatus according to claim 1,
wherein the adjustment unit adjusts at least an internal parameter and an external parameter of an image capturing apparatus as the camera parameters.

7. The image processing apparatus according to claim. 1,
wherein the adjustment unit adjusts parameters of an illumination apparatus, too, in addition to the camera parameters.

8. The image processing apparatus according to claim 7
wherein the parameters of the illumination apparatus are an illuminance and a color temperature.

9. An image processing method comprising
adjusting camera parameters on a basis of a comparison result between a reference image based on images obtained by capturing images of a predetermined subject at different timings, and a captured image obtained by capturing an image of the same subject in a current environment.

10. A 3D model data generation method comprising
generating a 3D model of a second subject from a plurality of second captured images, and generating a virtual viewpoint image that views the generated 3D model of the second subject from a predetermined viewpoint, the plurality of second captured images being obtained by capturing images of the second subject by a plurality of image capturing apparatuses that use camera parameters adjusted on a basis of a comparison result between a reference image based on images obtained by capturing images of a first subject at different timings, and a first captured image obtained by capturing an image of the first subject in a current environment.
